(19) United States
(12) Patent Application Publication
(10) Pub. No.: US 2018/0183719 A1
(43) Pub. Date: Jun. 28, 2018

(54) METHOD AND DEVICE FOR DATA TRANSMISSION

(71) Applicant: THOMSON Licensing, Issy-les-Moulineaux (FR)

(72) Inventor: Kai XIE, BEIJING (CN)

(21) Appl. No.: 15/739,725

(22) PCT Filed: Jun. 25, 2015
(86) PCT No.: PCT/CN2015/082340

§ 371 Date: Dec. 23, 2017

(51) Int. Cl. H04L 12/805; H04L 12/835; H04L 29/08

(52) U.S. Cl. CPC H04L 47/365; H04L 69/22; H04L 67/2842; H04L 47/30

(57) ABSTRACT

There is disclosed a method and a device for data transmission. The method comprises encapsulating a data stream to be transmitted into a plurality of packets; transmitting the plurality of packets in sequence; suspending transmission of the packets according to a first condition; and resuming transmission of remaining packets according to a second condition; wherein the suspending and the resuming are repeated until the transmission of all the packets is completed. According to the method and the device for data transmission proposed in the present disclosure, the burst of the data transmission is avoided, and thus the possibility of data overflow in the cache or buffer of the receiver or the intermediary device is decreased significantly. Accordingly, the reliability of the data transmission is improved while maintain the data transmission in real-time.

### TECHNICAL FIELD

The present disclosure relates to data transmission, and particularly to a method and device for data transmission.

### BACKGROUND

Currently, various data transmission applications, such as video data transmission, audio data transmission, text data transmission, and the like, become increasingly popular over a network, such as internet or intranet. Accordingly, the requirement for data transmission is higher than before. For example, a video application, such as video conference, video chat, and Video on Demand and the like, needs transmitting video data in real time as much as possible. In order to expedite the transmission speed, some transmission protocols with minimum or without flow control or acknowledge mechanism, such as User Data Protocol (UDP), are widely used in such video applications. Taking the UDP as an example, it uses a simple connectionless transmission model with minimum flow control mechanism to realize data transmission in real time. However, since the data cache/buffer of some facilities, such as gateways, routers and Access Points (AP), is limited, it means that it is of great possibility that the data cache/buffer is overflowed if a multitude of data arrives at the data cache/buffer at same time or during a short period. In such a case, the subsequent data may be lost due to insufficient capacity of the data cache/buffer. As a result, the quality of video would be deteriorated, and the user would have a poor experience.

### SUMMARY

According to one aspect of the present disclosure, there is provided a method for data transmission, comprising: encapsulating a data stream to be transmitted into a plurality of packets; and starting to transmit the plurality of packets in sequence; suspending transmission of the packets according to a first condition; and resuming transmission of remaining packets according to a second condition; wherein the suspending and the resuming are repeated until the transmission of all the packets is completed.

According to another aspect of the present disclosure, there is provided a device for data transmission, comprising: an encapsulator configured to encapsulate a data stream into a plurality of packets; a transmission interface configured to transmit the plurality of packets in sequence; a controller configured to control the transmission interface to suspend transmission of packets according to a first condition, and to control the transmission interface to resume transmission of remaining packets according to a second condition.

According to another aspect of the present disclosure, there is provided a computer readable medium storing program code instructions which cause a computer to implement the method for data transmission as described above.

These and other aspects, features and advantages of the present disclosure will become apparent from the following detailed description of exemplary embodiments, which is to be read in connection with the accompanying drawings.

### BRIEF DESCRIPTION OF THE DRAWINGS

The present disclosure may be better understood when reading the description as follows with reference to the following accompanying figures, in which:

FIG. 1 illustrates a schematic diagram of network architecture for data transmission;

FIG. 2 schematically illustrates a principle of a solution for data transmission in accordance with an embodiment of the present disclosure;

FIG. 3 illustrates a schematic diagram of data flow in the solution for data transmission in accordance with an embodiment of the present disclosure;

FIG. 4 illustrates a schematic flowchart of a method for data transmission in accordance with another embodiment of the present disclosure;

FIG. 5 illustrates a schematic flowchart of another method for data transmission in accordance with an embodiment of the present disclosure; and

FIG. 6 illustrates a schematic diagram of a device for data transmission in accordance with an embodiment of the present disclosure;

### DETAILED DESCRIPTION

To illustrate the technical solutions of the present disclosure clearly and fully, hereinafter, detailed description will be made to the embodiments of the present disclosure with reference to the accompanying drawings. It should be appreciated that those skilled in the art will be able to devise various arrangements that, although are not explicitly described or illustrated herein, embody an inventive concept of the present disclosure and thus are intended to fall into the scope of the present disclosure.

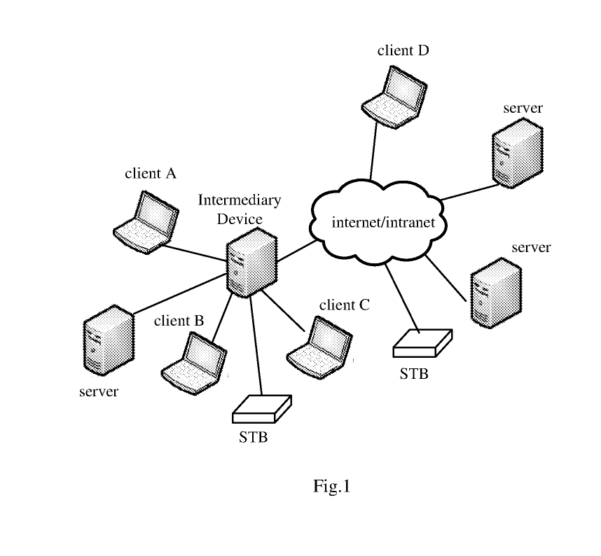

FIG. 1 illustrates a schematic diagram of network architecture for data transmission. As illustrated in FIG. 1, a plurality of clients and a plurality of hosts are connected to an intermediary device via wire or wireless connections, and the intermediary device is further connected to a plurality of hosts and a plurality of clients via wire or wireless communication networks, e.g. Internet or Intranet. It is appreciated for those skilled in the art that as an example, the number of the clients, that of the intermediary device and that of the hosts are only illustrative, and thus the present principle is not limited to this. Optionally, the client can be a Set-Top Box, a Personal Computer, a mobile phone, a Personal Data Assistant (PDA) with a communication function, the intermediary device can be a gateway, a router, an Access point, or the like, and the host can be a remote server, a database, or the like.

As mentioned above, in a time-critical data transmission, a transmission protocol without flow control or acknowledge mechanism, such as UDP, is overwhelmingly used over transmission network so as to achieve data transmission in real time as much as possible. Taking a case in which a client is connected to a host or a server via a gateway as an example, when the host needs to transmit data to the client via the gateway in response to the request from the client, the host encapsulates data into a plurality of packets, and then sends the plurality of packets to the gateway. In view of a high bandwidth of the network, the plurality of packets might arrive at a network interface of the gateway at almost the same time. In such a case, if a great multitude of data is received at the network interface simultaneously or during a very short time period, that is, a burst occurs upon receiving data, and an overflow in the data cache/buffer of the gateway is inevitable since the capacity of the data cache/buffer of the gateway is limited and there is not enough space for accommodating the data which arrives subsequently. Therefore, a packet loss might take place, which would decrease the quality of the data transmission. Depending on the extent of the packet loss, the user's experience might be deteriorated.

In below embodiments, a flow control is introduced into the data transmission without acknowledge mechanism, that is, after one or more packets are transmitted to a communication link, the transmission is suspended until a predetermined condition is satisfied; then, the transmission is resumed, and the remaining packets are transmitted, so that the intermediary device/the receiver has sufficient time to process the packets as previously received and make room in the data cache/buffer for accommodating the packets arriving subsequently. In such a case, it avoids the overflowing due to the limited capacity of the data cache/buffer, thus preventing a heavy packet loss from occurring, and improving the user's experience.

In embodiments of the present disclosure, UDP can be taken as an example for illustrating the solutions of the present disclosure. However, the scope of the present disclosure is not limited to the transmission with UDP mechanism. In fact, the solutions of the present disclosure can be applied to any data transmission without flow control or acknowledge mechanism to improve the reliability of a data transmission while maintaining a high speed transmission for real-time applications.

It should be noted that reference in the specification to “one embodiment” or “an embodiment” of the present disclosure, as well as other variations thereof, means that a particular feature, structure, characteristic, and so forth described in connection with the embodiment is included in at least one embodiment of the present disclosure. Thus, the appearances of the phrase “in one embodiment” or “in an embodiment”, as well any other variations, appearing in various places throughout the specification are not necessarily all referring to the same embodiment.

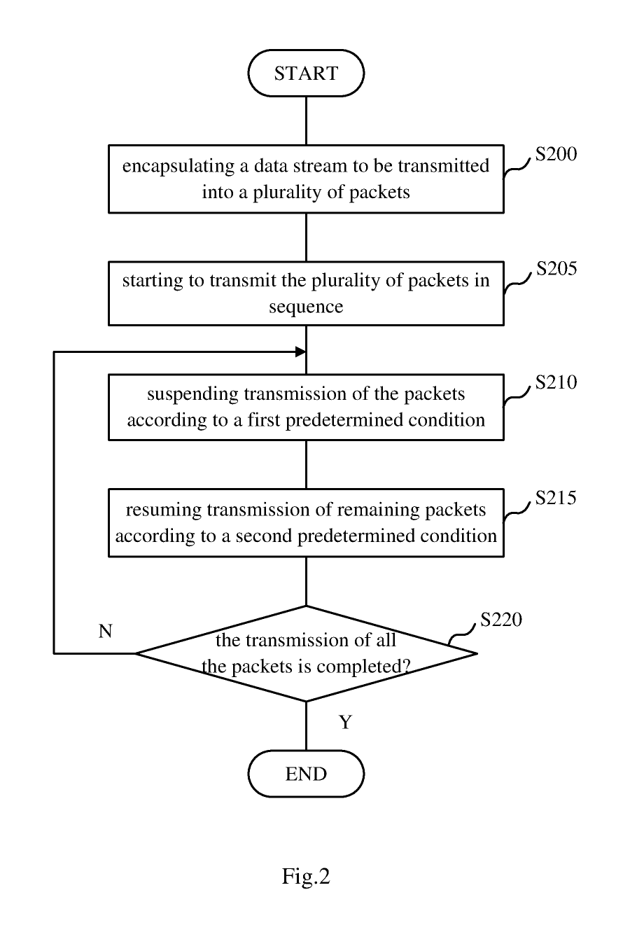

FIG. 2 illustrates a principle of a solution in accordance with an embodiment of the present disclosure. As illustrated in FIG. 2, at step S200, a transmitter (e.g., a server, a STB, or a client, etc.) firstly encapsulates a data stream, such as a video data stream, into a plurality of packets; after that, at step S205, the transmitter starts to transmit the packets to the receiver directly or via an intermediary device (for example, a gateway); at step S210, when a first predetermined condition is satisfied, the transmitter stops transmitting the packets until a second predetermined condition is met; after that, at step S215, the transmitter resumes transmitting the remaining packets to the receiver until the first predetermined condition is satisfied again; subsequently, at step S220, the transmitter repeats the above procedures until it completes transmission of all the packets.

Herein, the term of “receiver” should be broadly construed as a device which can receive data from various sources. Therefore, an intermediary device, such as a gateway, a router, an Access Point can also be referred as a receiver. Naturally, the term of “receiver” can also refer to a user terminal, such a client, a STB, a PDA or a mobile phone.

Similarly, in the present disclosure, the term of “transmitter” should be broadly construed as a device which can transmit data to various destinations. Therefore, in a specific scenario, an intermediary device, such as a gateway, a router, an Access Point can also be referred as a transmitter. Naturally, the term of “transmitter” can also refer to a user terminal, such a client, a STB, a PDA or a mobile phone in a case in which it sends data.

Further, the term of “communication link” can refer to a wire link or a wireless link for communication, and can comprise but not limited to a link over LAN, WLAN, or WAN.

Optionally, the first predetermined condition is that a total data amount of the packets or the total number of the packets which have been sent continuously reaches a first preset threshold. In such a case, while transmitting the packets, the transmitter calculates the total data amount of the packets or the total number of the packets which have been sent continuously; when the total data amount or the total number of the packets reaches the first preset threshold, the transmitter would stop transmitting the packets and waits for a second predetermined condition to be met.

As an alternative, the first predetermined condition is in that a time period in which the packets are continuously transmitted reaches a second preset threshold. In such a case, while transmitting the packets, the transmitter counts the time period for continuously transmitting the packets; when the time period reaches the second preset threshold, the transmitter would stop transmitting the packets and waits for a second predetermined condition to be met.

Optionally, at least one of the first preset threshold and the second preset threshold can be set based on at least one of the following: a capacity of a cache/buffer in the intermediary device/the receiver, a bandwidth of a communication link between the transmitter and the intermediary device/the receiver, a capability of the intermediary device/the receiver to process data, the number of transmitters over the communication link, and the like. For example, if the capacity of the cache/buffer in the intermediary device/the receiver is sufficient, the first preset threshold can be set as a large value.

Further, at least one of the first preset threshold and the second preset threshold can vary from time to time. That is, depending on a current condition of the network, such as congestion, packet loss rate, the number of transmitters which transmit data to the communication link simultaneously, and the like, the first preset threshold might vary. For instance, if the packet loss rate increases, the first preset threshold would be changed to a small value for a transmission of subsequent packets.

Optionally, the second predetermined condition is that a delay time expires, wherein the delay time can be set depending on an estimation of the capacity of the cache/buffer in the intermediary device/the receiver, the bandwidth of the communication link between the transmitter and the intermediary device/the receiver, the capability of the intermediary device/the receiver to process data, the number of the transmitters over the communication link, and the like. For example, if the processing ability of the processor in the intermediary device/the receiver is strong, a small delay time can be set.

Optionally, a delay time is inserted between two successive packets, which means that after the transmitter sends one packet to the receiver, it stops and waits until the corresponding delay time expires; and then, the transmitter resumes transmitting a next packet to the receiver.

Further, the delay time can be fixed to a constant value. For example, for a simple networking environment, such as in a video chat application, a client is connected to another client via an intermediary device (e.g. gateway), and the delay time can be fixed to e.g. 5 ms. With the delay time, the intermediary device has an opportunity to process the data previously received and to make room (or to prepare usable space) in the cache for receiving the subsequent packets, thus avoiding the overflowing in the cache.

Similarly, the delay time can vary depending on a current condition of the network, such as congestion, packet loss rate, the number of transmitters which transmit data to the communication link simultaneously, and the like. For instance, if the packet loss rate increases, the delay time would be changed to a larger value before subsequent packets are transmitted.

The inventor(s) further finds that in a more complicated networking environment, for example, in a case of a video data transmission in which more than one STB is connected to one gateway or more than one video application is running simultaneously on one STB, the video packets from different video streams would overlap if the delay time between successive transmissions is fixed.

In view of the above, it is proposed to apply a delay time having a random value between successive transmissions to decrease the probability of such overlapping.

Since the delay time having a random value is inserted between successive transmissions, even if a plurality of transmitters sends data streams to a same receiver simultaneously, the possibility, that the packets from different data streams arrive at the same receiver simultaneously and thus overlap each other, is decreased significantly.

Optionally, the random value is generated by a random function. For data streams from different sources, different seeds can be used for initializing the random function for respective data streams. In other words, the seed of the random function for different data stream is unique to avoid the overlapping of the packets from different data streams. In such a case, even if a same random function is used for all the data streams, different random values are generated by the same random function for respective data streams. Therefore, the delay time periods between successive transmissions of different data streams are different from each other, the possibility of the overlapping of the packets from different data streams is decreased as much as possible.

Optionally, the seeds can be based on the current time, etc.

Optionally, the seeds of the random function might be generated by another random function. That means that the random values are generated in an iterative mode.

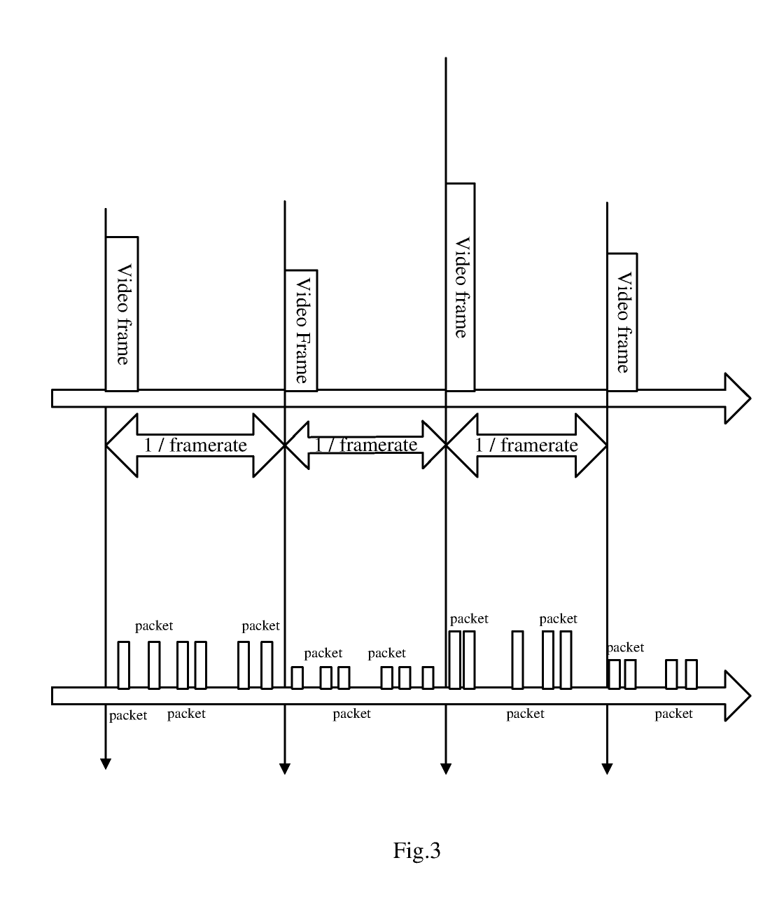

FIG. 3 illustrates a schematic diagram of data flow in the solution for data transmission in accordance with a second embodiment of the present disclosure. As illustrated in FIG. 3, a video data transmission is taken as an example, in which one video frame is split into a plurality of packets. After sending one packet, the transmitter stops transmission until a delay time elapses; then, the transmitter resumes transmitting a subsequent packet, and repeats the above procedures, until all of the packets in the video frame are transmitted; wherein, the delay time between two consecutive packets can vary depending on the condition of the network. The total delay time in transmission of one video frame is less than a reciprocal value of the frame rate of the video stream.

It should be noted that in FIG. 3, as an example, after one packet is transmitted, a delay time is introduced. However, as mentioned above, it is possible that a delay time is inserted only after several packets are sent, wherein the number of the packets sent continuously at one time can be set according to the condition of the network, such as the capacity of the cache/buffer in the intermediary device/the receiver, the bandwidth of the communication link between the transmitter and the intermediary device/the receiver, the capability of the intermediary device/the receiver to process data, the number of the transmitters over the communication link, and the like.

Further, the value of the delay time can be fixed or variable. Optionally, for a simple networking environment, the delay time can be set as a fixed value, such as 1 ms, 5 ms, or the like. The larger the number of the packets which are sent previously is, the longer the subsequent delay time would be.

Additionally, in a more complicated networking environment, for example, in a case in which more than one host transmits data packets to a same intermediary device or a same client simultaneously, the video data from different video streams would overlap if the delay time between successive transmissions is fixed.

In such a case, the delay time with a random value might be applied. That is, between two successive transmissions, there is inserted a random delay time, so that even if a plurality of hosts send data streams to a same client simultaneously, the possibility, that the packets from different data streams arrive at the same client simultaneously is decreased greatly, thus reducing the overlapping of the packets.

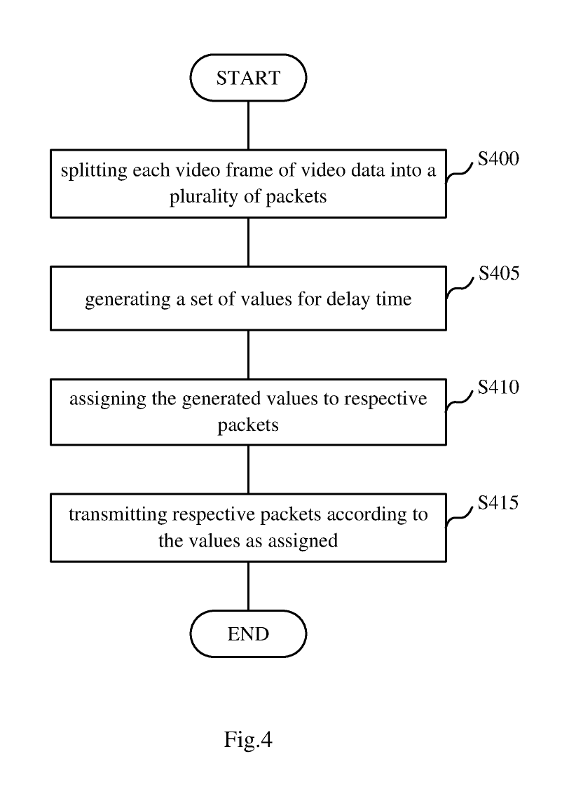

According to one aspect of the present disclosure, there is provided a method for data transmission. FIG. 4 illustrates a schematic flowchart of a method for transmitting data streams according to an embodiment of the present disclosure. Although in FIG. 4, a video data transmission is taken as an example, the method provided in the present disclosure is not limited to the video data transmission. Actually, the method can be applied to any data transmission, comprising but not limited to transmission of audio data, image data, text data and the like.

As illustrated in FIG. 4, at step S400, each of video frames in a data stream is encapsulated into a plurality of packets, that is, each video frame of video data is split into a plurality of packets, for example, into N packets; herein, each video frame can be split into a plurality of packets based on the protocol RFC 3984. Nevertheless, RFC 3984 is only for illustration, and any mechanism for splitting a video frame into packets can be applied in the method provided in the present disclosure; at step S405, a set of values for delay time are generated based on the number of the packets, for example, N values, such as d₀ to d_{N-1}, are generated, wherein each of the values di is between 0 to a reciprocal value of the frame rate of the video data; at step S410, the values are sorted in ascending order or descending order, and assigned to respective packets; for example, the least value is assigned to the packet to be sent firstly, the second least value is assigned to the packet to be sent secondly, and so on, until the maximum value is assigned to the packet to be sent lastly; at step S415, respective packets are transmitted according to the value as assigned, that is, the packet with a smaller value of the delay time will be transmitted firstly, until the last packet with the maximum value of the delay time is transmitted; after all the packets in a video frame are transmitted, the above procedures are repeated for a next video frame.

Optionally, a total value of the delay time in one frame of video is less than a reciprocal value of a frame rate of the video so as to guarantee the smooth of the viewing on the video.

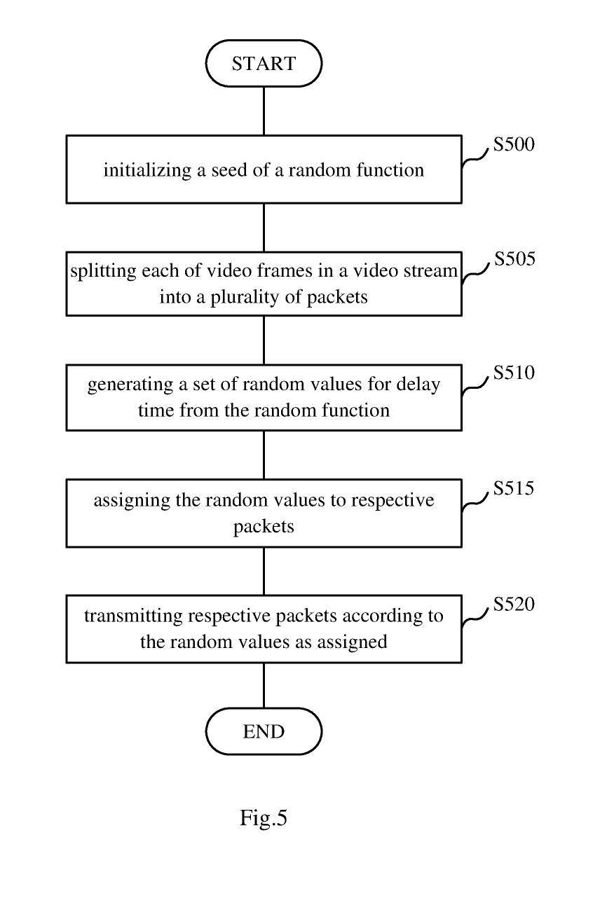

FIG. 5 illustrates a schematic flowchart of a method for transmitting data streams according to another embodiment of the present disclosure. Compared with FIG. 4, the difference is mainly in that the value of the delay time is random. Similar to FIG. 4, a video data transmission is taken as an example, however the method provided in the embodiment is not limited to the video data transmission. Actually, the method can be applied to any data transmission, comprising but not limited to transmission of audio data, image data, text data and the like.

As illustrated in FIG. 5, at step S505, each of video frames in a data stream is encapsulated into a plurality of packets, that is, each video frame of video data is split into a plurality of packets, for example, into N packets, based on the protocol RFC 3984; at step S510, a set of random values for delay time are generated based on the number of the packets, for example, N random values, such as d₀ to d_{N-1}, are generated according to a random function, wherein each of the random values di is between 0 to a reciprocal value of the frame rate of the video data; at step S515, the random values are sorted in ascending order or descending order, and assigned to respective packets; for example, the least random value is assigned to the packet to be sent firstly, the second least random value is assigned to the packet to be sent secondly, and so on, until the maximum random value is assigned to the packet to be sent lastly; at step S520, respective packets are transmitted according to the random value as assigned, that is, the packet with a smaller random value of the delay time will be transmitted firstly, until the last packet with the maximum random value of the delay time is transmitted; after all the packets in a video frame are transmitted, the above procedure are repeated for a next video frame.

Optionally, the method illustrated in FIG. 5 can further comprise, before generating the random values according to the random function, initializing a seed of the random function.

Optionally, as mentioned above, in order to decreasing the possibility of the overlapping of the packets from different data streams, in a case in which a same random function is used for video streams from different sources, the method as illustrated in FIG. 5 can further comprise initializing the seed of the random function with different values.

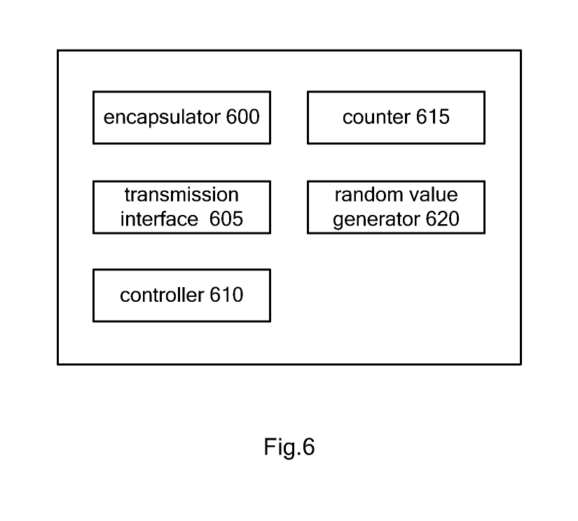

According to another aspect of the present disclosure, there is provided a device for data transmission. As illustrated in FIG. 6, the device for data transmission comprises: an encapsulator 600 configured to encapsulate data, e.g. a video frame, into a plurality of packets; a transmission interface 605 configured to transmit the plurality of packets in sequence; a controller 610 configured to control the transmission interface 610 to suspend data transmission according to a first predetermined condition, and to control the transmission interface 610 to resume data transmission according to a second predetermined condition. In an embodiment, the encapsulator and the controller can be implemented by a processor with program instructions or two separate processors with program instructions. The transmission interface can be implemented by a physical transceiver.

Optionally, the first predetermined condition is in that a total data amount of the packets or the total number of the packets which have been sent continuously reaches a first preset threshold. Optionally, the first predetermined condition is in that a time period for continuously transmitting the packets reaches a second preset threshold. In such a case, the device for data transmission can further comprise a counter 615 configured to count a total size of the packets sent continuously or count a time period for sending the packets continuously. In an embodiment, the counter is implemented by a processor.

Optionally, the second predetermined condition is in that a delay time elapses. In such a case, the device for data transmission can further comprise a counter 615 configured to count the delay time.

Optionally, the device for data transmission can further comprise a random value generator 620 configured to generate random values for the delay time. In an embodiment, the generator is implemented by a processor.

As readily conceived by one of ordinary skill in the art, the teachings of the present disclosure may be implemented in various forms of hardware, software, firmware, special purpose processors, or combinations thereof.

Optionally, the teachings of the present disclosure are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

By introducing fixed/random delay between successive transmission, the method and the device for data transmission provided in the embodiments of the present disclosure can reduce the burst of the data transmission, and decrease the probability of data overflow which might occur due to the limited capacity of the cache or buffer under the protocol without flow control or acknowledge mechanism.

Therefore, the method and the device for data transmission provided in the embodiments of the present disclosure can reduce the packet loss in the data transmission while maintaining the real-time data transmission as much as possible, thus enhancing the reliability of the data transmission, and improving the user's experience.

Furthermore, it is provided a computer program product downloadable from a communication network and/or recorded on a medium readable by computer and/or executable by a processor, comprising program code instructions for implementing the steps of a method as aforementioned.

Furthermore, it is provided Non-transitory computer-readable medium comprising a computer program product recorded thereon and capable of being run by a processor, including program code instructions for implementing the steps of a method as aforementioned.

The embodiments of the invention being thus described, it will be obvious that all the embodiments may be varied in many ways. Such variations should not be regarded as a departure from the scope of the invention, and all such modifications as would be obvious to those skilled in the art are intended to be included within the scope of the following claims.

1. A method for transmitting video frames of a data stream, comprising:
encapsulating a video frame to be transmitted into a plurality of packets;
assigning a plurality of values for the delay time to the plurality of packets, wherein each value of the plurality of values for delay time is between 0 and a reciprocal value of frame rate of the video frames;
transmitting the plurality of packets for the video frame based on the plurality of values for delay time assigned to the plurality of packets.

2. The method of claim 1, further comprising assigning each packet of the plurality of packets with one value of the plurality of values.

3. The method of claim 2, further comprising assigning several packets of the plurality of packets with one value of the plurality of values.

4. The method of claim 1, further comprising sorting the plurality of values in ascending order or descending order.

5. The method of claim 1, further comprising randomly generating the plurality of values.

6. The method of claim 1, wherein a transmission protocol that is used to transmit the plurality of packets for the video frame is a transmission protocol without flow control or acknowledge mechanism.

7. (canceled)

8. A device for transmitting video frames of a data stream, comprising:
an encapsulator configured to encapsulate a video frame to be transmitted into a plurality of packets;
a transmission interface configured to transmit the plurality of packets;
a controller configured to assign a plurality of values for delay time to the plurality of packets and control the transmission interface to transmit the plurality of packets for the video frame based on the plurality of values for delay time assigned to the plurality of packets, wherein each value of the plurality of values for delay time is between 0 and a reciprocal value of frame rate of the video frames.

9. The device of claim 8, wherein the controller is further configured to assign each packet of the plurality of packets with one value of the plurality of values.

10. The device of claim 8, wherein the controller is further configured to assign several packets of the plurality of packets with one value of the plurality of values.

11. The device of claim 8, wherein the controller is further configured to sort the plurality of values in ascending order or descending order.

12. The device of claim 8, wherein the controller is further configured to randomly generate the plurality of values.

13. The device of claim 8, wherein a transmission protocol that is used to transmit the plurality of packets for the video frame is a transmission protocol without flow control or acknowledge mechanism.

14. (canceled)

15. A computer program product downloadable from a communication network and/or recorded on a medium readable by computer and/or executable by a processor, comprising program code instructions for implementing the method of claim 1.

16. A non-transitory computer-readable medium comprising a computer program product recorded thereon and capable of being run by a processor, including program code instructions for implementing the method of claim 1.
